(19) United States
(12) Patent Application Publication
(10) Pub. No.: US 2024/0286293 A1
(43) Pub. Date: Aug. 29, 2024

(54) SELF-ALIGNING GRIPPER ASSEMBLIES FOR ROBOTIC ARMS

(71) Applicant: Meso Scale Technologies, LLC., Rockville, MD (US)

(72) Inventors: Slavi MIRTCHEV, Annandale, VA (US); Gary I. KRIVOY, Clarksburg, MD (US); Manish KOCHAR, Rockville, MD (US); Aaron H. LEIMKUEHLER, Upper St Clair, PA (US)

(73) Assignee: Meso Scale Technologies, LLC., Rockville, MD (US)

(21) Appl. No.: 18/585,520

(22) Filed: Feb. 23, 2024

Related U.S. Application Data
(60) Provisional application No. 63/486,741, filed on Feb. 24, 2023.

(51) Int. Cl. B25J 15/00; G01N 35/00

(52) U.S. Cl. CPC B25J 15/0028; G01N 35/0099

(57) ABSTRACT

A gripper assembly for a robotic arm includes a gripper finger having a first end and a second end, a gripper pad pivotably coupled to the gripper finger such that the gripper pad is permitted to rotate about a rotational axis relative to the gripper finger, the gripper pad having a pair of sides with one of the sides forming a gripping surface configured to grip an object, and a proximal side located between the pair of sides, and a gripper pad aligner including a pad alignment element coupled to the gripper pad and a finger alignment element coupled to the gripper finger, wherein the pad alignment element is coupled to the finger alignment element and configured to apply an aligning torque to the gripper pad that, when applied, rotates the gripper pad toward a first angular orientation about the rotational axis between the gripper pad and the gripper finger.

### CROSS-REFERENCE TO RELATED APPLICATIONS

This application claims the benefit of U.S. provisional patent Application No. 63/486,741, filed Feb. 24, 2023, which is hereby incorporated herein by reference in its entirety.

### STATEMENT REGARDING FEDERALLY SPONSORED RESEARCH OR DEVELOPMENT

Not applicable.

### BACKGROUND

Robotic arms are utilized in a wide array of industries for automating with speed and precision repetitive tasks that would otherwise conventionally be performed manually. Robotic arms typically include a first end or base and a second or free end opposite the base and which may have one or more degrees of freedom relative to the base which may be moveable or fixed relative to a support structure of the system in which the robotic arm is incorporated. As an example, robotic arms may include one or more articulating joints, actuators (linear, rotary, etc.), and other components to allow for the free end of the robotic arm to move and be positioned as desired by an operator of the robotic arm. Additionally, robotic arms may include a tool at the free end thereof for manipulating one or more workpieces or other objects as part of performing the tasks given to the robotic arm. For example, the robotic arm may include a cutting element, a welding element, or other tool for manipulating an object. As another example, the robotic arm may include one or more grippers for gripping an object such that the robotic arm may pick up and reposition the object as desired.

### BRIEF SUMMARY OF THE DISCLOSURE

An embodiment of a gripper assembly for a robotic arm comprises a gripper finger having a longitudinal first end and a longitudinal second end opposite the first end, a gripper pad pivotably coupled to the gripper finger such that the gripper pad is permitted to rotate about a rotational axis relative to the gripper finger, the gripper pad having a pair of lateral sides with one of the lateral sides forming a gripping surface configured to grip an object, and a proximal side located between the pair of lateral sides, and a gripper pad aligner comprising a pad alignment element coupled to the gripper pad and a finger alignment element coupled to the gripper finger, wherein the pad alignment element is coupled to the finger alignment element and configured to apply an aligning torque to the gripper pad that, when applied, rotates the gripper pad toward a first angular orientation about the rotational axis between the gripper pad and the gripper finger. In some embodiments, the pad alignment element comprises a biasing member configured to apply a biasing force to the gripper pad that, when applied, rotates the gripper pad toward the first angular orientation. In some embodiments, the biasing member comprises a spring wire and the biasing force applied by the spring wire results from an elongation of the spring wire. In certain embodiments, the pad alignment element comprises a biasing finger having a fixed end coupled to the finger alignment element and a free end opposite the fixed end, and wherein the biasing force applied by the biasing finger results from a bending of the biasing finger. In certain embodiments, the finger alignment element comprises a base securable to the gripper finger and the pad alignment element comprises a biasing finger extending from the base toward the gripper pad, and wherein at least a portion of the biasing finger abuts one of the lateral sides of the gripper pad to bias the gripper pad toward the first angular orientation. In some embodiments, the pad alignment element comprises a plurality of the biasing fingers each abutting a first lateral side of the pair of lateral sides of the gripper pad to bias the gripper pad toward the first angular orientation. In some embodiments, the pad alignment element comprises a first magnetic member and the finger alignment element comprises a second magnetic member magnetically coupled to and magnetically attracted toward the first magnetic member. In certain embodiments, the second magnet member is formed integrally with the gripper finger. In certain embodiments, the second magnetic member comprises a boss surrounded by a channel formed in a surface of the gripper finger, and wherein the boss extends toward the proximal side of the gripper pad and is aligned with the first magnetic member when the gripper finger is in the first angular orientation. In some embodiments, the boss comprises a magnetic material and is integrally formed with the gripper finger. In some embodiments, the boss is attachable to the gripper finger and comprises a magnetic material that is different from a material comprising the gripper finger. In certain embodiments, the first magnetic member comprises a magnet attachable to the gripper pad. In some embodiments, the gripper assembly comprises a pivot pin extending from the gripper finger to the proximal side of the gripper pad to pivotably couple the gripper pad to the gripper finger. An embodiment of an assay system comprises a container containing a reagent, and a pair of robotic arms configured to manipulate the position of the container, wherein each of the robotic arms comprises a pair of the gripper assemblies configured to grip the container between the pair of robotic arms.

An embodiment of a gripper assembly for a robotic arm comprises a gripper finger having a longitudinal first end and a longitudinal second end opposite the first end, a gripper pad pivotably coupled to the gripper finger such that the gripper pad is permitted to rotate about a rotational axis relative to the gripper finger, the gripper pad having a pair of lateral sides with one of the lateral sides forming a gripping surface configured to grip an object, and a proximal side located between the pair of lateral sides, and a gripper pad aligner comprising a pad alignment element coupled to the gripper finger and offset from the rotational axis by a predetermined distance, wherein the pad alignment element is configured to apply an aligning torque to the gripper pad oriented in the direction of a first angular orientation about the rotational axis between the gripper pad and the gripper finger. In some embodiments, the pad alignment element comprises a magnetic member received in an aperture formed in the proximal side of the gripper pad. In some embodiments, the gripper pad aligner comprises a magnetic boss extending from a side of the gripper finger and surrounded by a channel formed in the side of the gripper finger, and wherein the magnetic boss magnetically attracts the pad alignment element and is aligned with the pad alignment element when the gripper finger is in the first angular orientation. In certain embodiments, the boss comprises a magnetic material and is integrally formed with the gripper finger. In certain embodiments, the boss is attachable to the gripper finger and comprises a magnetic material that is different from a material comprising the gripper finger. In some embodiments, the pad alignment element comprises a magnet coupled to the gripper pad. In some embodiments, the pad alignment element comprises an elongate biasing finger which abuts one of the pair of lateral sides of the gripper pad and extends toward the gripper finger. In certain embodiments, the pad alignment element comprises a spring wire and the aligning torque comprises a biasing force applied by the spring wire due to an elongation of the spring wire. In certain embodiments, the gripper pad aligner comprises a finger alignment element coupled to the gripper pad and offset from the rotational axis by the predetermined distance. In some embodiments, the pad alignment element comprises a first magnetic member and the finger alignment element comprises a second magnetic member magnetically attracted toward the pad alignment element. In some embodiments, the gripper pad comprises a second angular orientation that is spaced from the first angular orientation in a first rotational direction about the rotational axis, and wherein the alignment element applies a rotational torque in a second rotational direction, opposite the first rotational direction, when the gripper pad is in the second angular orientation, and the gripper pad comprises a third angular orientation that is spaced from the first angular orientation in the second rotational direction about the rotational axis, and wherein the alignment element applies a rotational torque in the first rotational direction when the gripper pad is in the third angular orientation. In certain embodiments, the alignment element is configured to restore the gripper pad to the first angular orientation when the gripper pad is in a second angular orientation spaced from the first angular orientation in a first rotational direction, and when the gripper pad is in a third angular orientation spaced from the first angular orientation in a second rotational direction, opposite the first rotational direction. In certain embodiments, the gripper assembly comprises a pivot pin extending from the gripper finger to the proximal side of the gripper pad to pivotably couple the gripper pad to the gripper finger.

An embodiment of a gripper assembly for a robotic arm comprises a gripper finger having a longitudinal first end and a longitudinal second end opposite the first end, a gripper pad pivotably coupled to the gripper finger such that the gripper pad is permitted to rotate about a rotational axis relative to the gripper finger, the gripper pad having a pair of lateral sides with one of the lateral sides forming a gripping surface configured to grip an object, and a proximal side located between the pair of lateral sides, and a gripper pad aligner comprising a base securable to the gripper finger and a biasing finger extending from the base toward the gripper pad and abutting one of the lateral sides of the gripper pad. In some embodiments, the gripper pad aligner comprises a plurality of the biasing fingers each abutting a first lateral side of the pair of lateral sides of the gripper pad to bias the gripper pad toward a first angular orientation. In some embodiments, the gripper pad comprises a second angular orientation that is spaced from the first angular orientation in a first rotational direction about the rotational axis, and wherein a first biasing finger of the plurality of the biasing fingers applies a rotational torque in a second rotational direction, opposite the first rotational direction, when the gripper pad is in the second angular orientation, and the gripper pad comprises a third angular orientation that is spaced from the first angular orientation in the second rotational direction about the rotational axis, and wherein a second biasing finger of the plurality of the biasing fingers applies a rotational torque in the first rotational direction when the gripper pad is in the third angular orientation. In certain embodiments, the gripper pad aligner is configured to restore the gripper pad to the first angular orientation when the gripper pad is in a second angular orientation spaced from the first angular orientation in a first rotational direction, and when the gripper pad is in a third angular orientation spaced from the first angular orientation in a second rotational direction, opposite the first rotational direction. In certain embodiments, the biasing finger comprises a pair of the biasing fingers each abutting a first lateral side of the pair of lateral sides of the gripper pad, and wherein the pair of the biasing fingers are at locations spaced from each other along a longitudinal axis of the gripper pad. In some embodiments, the base of the gripper pad aligner is formed monolithically with the finger.

An embodiment of a gripper assembly for a robotic arm comprises a gripper finger having a longitudinal first end and a longitudinal second end opposite the first end, a gripper pad having a pair of lateral sides with one of the lateral sides forming a gripping surface configured to grip an object, and a proximal side located between the pair of lateral sides, and a gripper pad aligner comprising a first magnetic member coupled to the gripper finger and a second magnetic member coupled to the gripper pad and magnetically attracted to the first magnetic member, wherein the second magnetic member is configured to apply an aligning torque to the gripper pad oriented in the direction of a first angular orientation about a rotational axis between the gripper pad and the gripper finger.

An embodiment of a gripper pad aligner for a gripper assembly of a robotic arm comprises a pad alignment element configured to couple to a gripper pad of the gripper assembly, and a finger alignment element configured to couple to a gripper finger of the gripper assembly, wherein the pad alignment element is configured to couple to the finger alignment element and configured to apply an aligning torque to the gripper pad when the finger alignment element is coupled to the gripper pad that, when applied, rotates the gripper pad toward a first angular orientation about a rotational axis between the gripper pad and the gripper finger.

### BRIEF DESCRIPTION OF THE DRAWINGS

For a detailed description of various exemplary embodiments, reference will now be made to the accompanying drawings in which:

FIG. 1 is a plan view of an embodiment of an automated assay system including a robotic arm;

FIG. 2 is a side view of an embodiment of a gripper assembly of a robotic arm of FIG. 1;

FIGS. 3-5 are bottom views of the gripper assembly of FIG. 2;

FIGS. 6-8 are additional bottom views of a pair of the gripper assemblies of FIG. 2;

FIGS. 9 and 10 are bottom views of another embodiment of a gripper assembly for a robotic arm;

FIG. 11 is a perspective view of an embodiment of a gripper pad aligner;

FIG. 12 is a perspective view of another embodiment of a gripper assembly for a robotic arm including the gripper pad aligner of FIG. 9;

FIG. 13 is a side view of another embodiment of a gripper assembly for a robotic arm;

FIG. 14 is a side view of another embodiment of a gripper assembly for a robotic arm;

FIG. 15 is a perspective view of another embodiment of a gripper assembly for a robotic arm; and

FIG. 16 is a perspective view of another embodiment of a gripper assembly for a robotic arm.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Additionally, the term “coupled,” “coupling,” “coupler,” and like terms are used broadly herein and can include any method, device, or arrangement for securing, binding, bonding, fastening, attaching, joining, inserting therein, forming thereon or therein, or otherwise associating, for example, mechanically, magnetically, electrically, chemically, operably, directly or indirectly with intermediate elements, one or more members together and can further include without limitation integrally forming one functional member with another in a unitary or monolithic fashion. The coupling can occur in any direction, including rotationally. Further, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

As previously described, robotic arms may be utilized in a wide variety of applications for manipulating one or more objects. One such example includes automated assay systems in which robotic arms are utilized to grip, manipulate, transport, and/or reposition various containers or other objects of the assay system. A robotic arm may be equipped with one or more grippers at a free end thereof for gripping and manipulating one or more objects. As an example, a robotic arm may include a pair of grippers each including a gripper pad configured to contact and thereby frictionally grip the object to be manipulated by the robotic arm. For instance, the robotic arm may include one or more actuators for pressing the pair of grippers against the object such that the robotic arm may pick up, transport, and set down or reposition the object as desired. Additionally, the gripper pads may be pivotably coupled to a gripper finger so that the gripper pad may remain in a tangential orientation relative to the exterior of the gripped object such that the likelihood of the robotic arm dropping or otherwise losing contact with the gripped object is minimized. Additionally, it may be understood that the actions and movements of the robotic arm, including the actuation of the grippers of the robotic arm, may be at least partially automated.

In some applications, a given robotic arm may be tasked with picking up or otherwise manipulating objects which are placed in close proximity with each other or other obstacles, leaving the robotic arm with minimal space for positioning the grippers thereof against an exterior of the object to be manipulated by the robotic arm. As just one example, biological assay systems often include a plurality of containers sometimes referred to as assay plates which contain biological materials utilized in performing biological assays.

In order to minimize the footprint of the assay system, at least some of the assay plates or other objects may be positioned adjacent each other such that only a minimal amount of space is provided between adjacently positioned assay plates. For example, the gap formed between adjacently positioned plates may only be slightly larger in width than the gripper pads of the robotic arm used for gripping and manipulating the assay plates. For this reason, a gripper having a gripper pad that is not oriented so as to minimize the width of the gripper may collide with the object to be grasped (e.g., an assay plate) or another obstacle (another assay plate or other object), thereby preventing the gripper from successfully grasping the object while also potentially damaging the gripper or other objects. For example, a gripper having a gripper pad oriented at a non-zero angle to a gripper finger of the gripper may result in the angled gripper pad colliding with the object to be grasped or another object, preventing the gripper from successfully grasping the object. Indeed, conventional grippers often become jammed (e.g., against objects positioned proximal an object to be grasped) or otherwise fail to properly grip objects to be grasped by the conventional gripper due to misalignment of the conventional gripper about a rotational axis thereof.

Accordingly, embodiments of self-aligning gripper assemblies for robotic arms are disclosed herein that include a gripper pad aligner for applying an aligning torque to a gripper pad of the gripper assembly that, when applied, rotates the gripper pad toward a desired angular orientation about a rotational axis such that the gripper pad may be maintained in the desired angular orientation. The gripper pad aligner may be coupled to both the gripper pad and a gripper finger of the gripper assembly at a location that is offset from the rotational axis. By rotating the gripper pad toward a desired angular orientation (e.g., following an engagement between the gripper pad and an object resulting in the rotation of the gripper pad away from the desired angular orientation) and maintaining the gripper pad in the desired angular orientation, various dimensions of the gripper (e.g., its width) may be minimized such that the gripper pad may not inadvertently collide with an object to be grasped or other obstructions.

Embodiments of gripper pad aligners include a pad alignment element coupled to the gripper pad of the gripper assembly, and a finger alignment element coupled to both the gripper finger and to the pad alignment element. Particularly, the finger alignment element may be mechanically, magnetically, or otherwise coupled to the pad alignment element whereby an aligning force may be transferred between the alignment elements.

For example, in some embodiments, the finger alignment element may comprise a base secured to the gripper finger while the pad alignment element may comprise a biasing finger extending from the base and contacting the gripper pad. In this configuration, rotation of the gripper pad may flex the biasing finger, resulting in the biasing finger applying the aligning torque to the gripper pad to return the pad to a particular angular orientation (such as, for example, a desired angular orientation which may or may not be fixed and predefined). In another example, the pad alignment element may comprise a magnetic member or magnet that is magnetically attracted to the finger alignment element in the form of a corresponding magnetic member having the opposite pole of the pad alignment element. This magnetic attraction between the pad alignment element and the corresponding finger alignment element results in the pad alignment element being magnetically coupled to the finger alignment element.

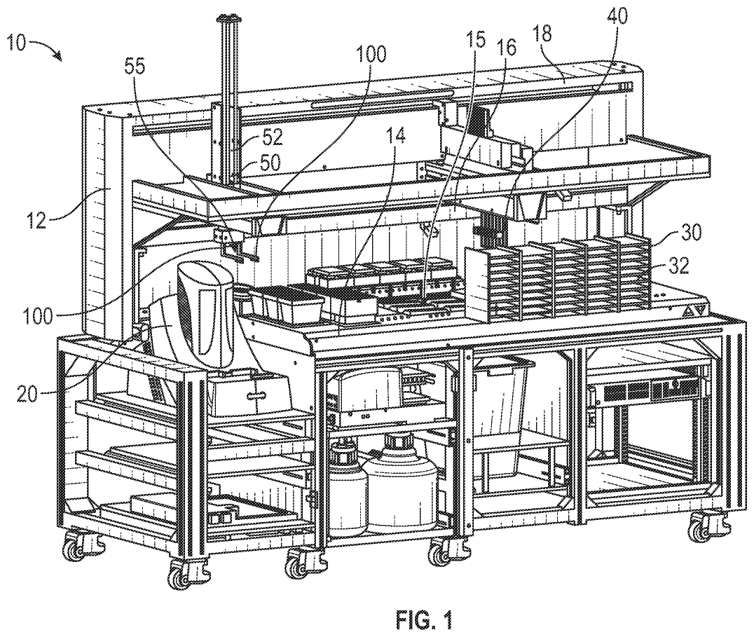

Referring now to FIG. 1, a plan view of an embodiment of an automated assay system 10 including a robotic arm 50 is shown. Assay system 10 may be used to perform biological assays and the operation of assay system 10 is at least partially automated in which some of the tasks are performed automatically by robotic devices (e.g., one or more robotic arms), such as, for example, with the aid of a collaborative machine or device, such as a cobot or the like, of the assay system 10 while other tasks are performed manually by one or more human operators of the assay system 10. As one example, robotic arms may automatically transport, as part of a preset routine, objects of the assay system 10 (e.g., assay plates and other types of containers) between different locations such as, for example, between a storage area and an assay reader. Additionally, some tasks such as pipetting may be performed manually alongside the robotic devices of the assay system 10. It may be understood, however, that in some embodiments assay system 10 may be fully automated without the need for manual intervention by a human operator.

In some embodiments, assay system 10 may include fully integrated, one-stop-shop instruments such as, for example, the PARSEC R 5000 instrument (P5) as disclosed in International Application No. PCT/US2016/043755; International Application No. PCT/US2017/014360; and U.S. Application No. 63/025,344, each of which is incorporated herein by reference in their entirety. In certain embodiments, assay system 10 may include an interconnected network of instruments and equipment for carrying our scientific testing, experimentation, and assay/vaccine development (e.g., assay readers, washers, plate shakers, incubators, etc.). In other examples, high throughput instruments, such as, for example those disclosed in U.S. Application No. PCT/US2016/026242; and International Application No. PCT/US2019/032567, each of which is incorporated herein by reference in their entirety.

In this exemplary embodiment, assay system 10 generally includes a support structure 12, an assay reader 20, an assay storage unit 30, a pipetting unit 40, and the robotic arm 50. Support structure 12 includes a platform or deck 14 upon which the assay storage unit 30 is located. Support structure 12 additionally includes a pair of gantries 16 and 18 located vertically above the platform 14. The pipetting unit 40 is supported by a lower gantry 16 of the pair of gantries 16 and 18 whereby the pipetting unit 40 is suspended vertically above the platform 14. Similarly, the robotic arm 50 is supported by an upper gantry 18 of the pair of gantries 16 and 18 whereby the robotic arm 50 is suspended above the platform 14. In this configuration, both the pipetting unit 40 and robotic arm 50 may travel in one or more direction (vertically, laterally) relative to the platform 14 in response to the activation of one or more actuators coupled between the pipetting unit 40 and the lower gantry 16, and between the robotic arm 50 and upper gantry 18.

The assay reader 20 of assay system 10 is configured for conducting biological, chemical, and/or biochemical experiments, such as, for example, assays (e.g., luminance-, chemiluminescence-, and/or electrochemiluminescence (ECL)-based assays) on biological samples (e.g., blood, plasma, etc.). In embodiments, the experiments may be performed on assay plates (e.g., 96-, 384-well microtiter plates, etc.) not shown in FIG. 1) which are insertable into the assay reader 20. Particularly, the assay trays may be stored in the assay storage unit 30 prior to or following the conduction of a biological assay on biological materials contained therein by assay reader 20. In some embodiments, assay reader 20 may include the one or more of the MESO SECTOR S 600, MESO QUICKPLEX SQ 120, and the MESO QUICKPLEX Q 60 instruments (available from Meso Scale Diagnostics, LLC. of Rockville, Maryland) including, for example, those disclosed in U.S. Pat. Nos. 6,977,722; 11,156,801; and International Application No. PCT/US2020/042104, each of which is incorporated by reference herein in their entirety. It may however be understood that the configuration of assay reader 20 may vary from the non-limiting set of examples outlined above.

Assay storage unit 30 is supported on the platform 14 of support structure 12 and includes a plurality of separate receptacles (one of which is indicated by arrow 32 in FIG. 1) for separately storing different assay plates. The pipetting unit 40 pipettes, through aspirating and/or dispensing functions, various materials (e.g., liquids) to or from one or more receptacles or wells formed within a given assay plate. Particularly, an assay plate may be positioned onto a preparation area 15 of the platform 14 and the pipetting unit 40 may be transported along lower gantry 16 into a position vertically above the assay plate. In this arrangement, the pipetting unit 40 may be lowered toward the assay plate located in the preparation area 15 such that pipetting unit 40 may pipette materials to or from the assay plate.

The robotic arm 50 of assay system 10 manipulates and transports the assay plates of system 10 (or other objects) between various locations. For example, robotic arm 50 may transport assay plates between corresponding receptacles 32 of assay storage unit 30 and the preparation area 15 of platform 14. Additionally, robotic arm 50 may transport assay plates between preparation area 15 and the assay reader 20 for the performance of a biological assay on the materials contained by the given assay plate.

In this exemplary embodiment, robotic arm 50 includes a body and a pair of self-aligning gripper assemblies or simply “grippers” 100 that extend from the body 52 for gripping the objects manipulated by the robotic arm 50 such as, for example, the assay plates of assay system 10. In this exemplary embodiment, grippers 100 extend parallel to one another such that an opening 55 is formed therebetween. Robotic arm 50 includes one or more actuators (not shown in FIG. 1) for moving the grippers 100 relative to each other such that the size of the opening 55 may be adjusted to accommodate the object to be grasped by the robotic arm 50. The one or more actuators may also cause the grippers 100 to press laterally against the object to be grasped by the robotic arm 50, establishing a normally directed force through friction between the object and the pair of grippers 100 such that the object may be vertically lifted and transported by the robotic arm 50.

It may be understood that assay system 10 may include additional equipment not explicitly described above such as a plate shaking unit, a plate washing unit, a waste storage unit, and a computer system for automatedly operating at least some of the equipment of assay system 10 including, for example, assay reader 20 and robotic arm 50. For example, the computer system may operate the robotic arm 50 to grasp a particular assay plate stored in one of the receptacles 32 of assay storage unit 30 as part of a predefined control routine or scheme.

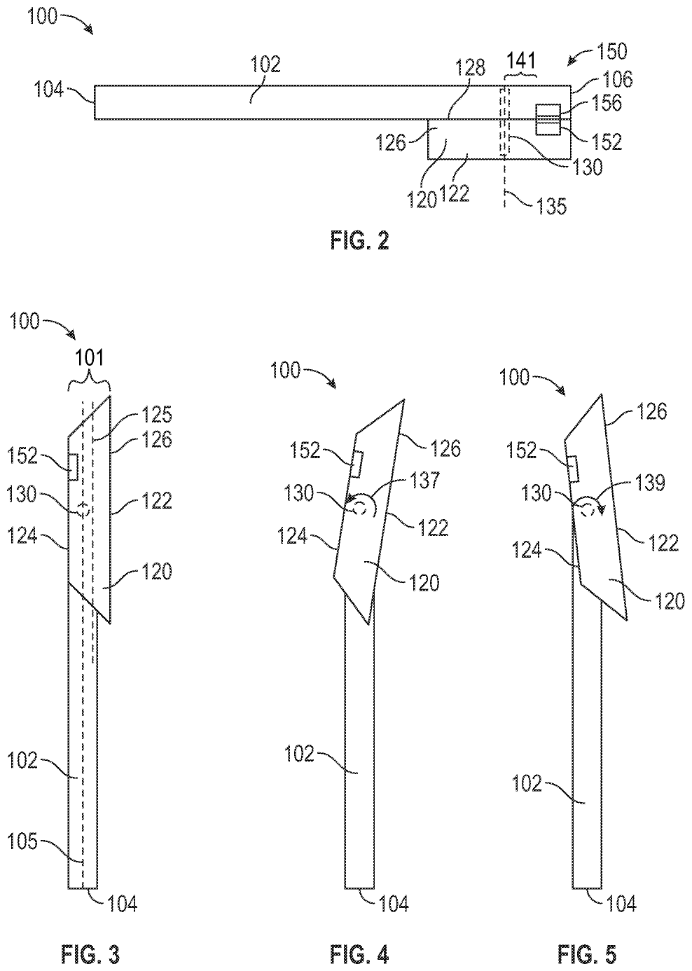

Referring now to FIGS. 2-5, an embodiment of one of the grippers 100 of robotic arm 50 is shown. While in this exemplary embodiment gripper 100 forms a component of robotic arm 50 and the assay system 10, it may be understood that gripper 100 may be utilized in robotic arms and other robotic equipment that vary in configuration from the robotic arm 50 shown in FIG. 1. Similarly, gripper 100 may be utilized in applications other than biological assay systems. For instance, gripper 100 may be utilized in manufacturing, agricultural, and other applications.

In this exemplary embodiment, gripper 100 generally includes a gripper finger 102, a gripper pad 120 pivotably coupled to the gripper finger 102, and a gripper pad aligner 150 coupled between the gripper finger 102 and gripper pad 120 as will be described further herein. Gripper finger 102 is elongate in shape having a first or fixed end 104 and a second or free end 106 longitudinally opposite the fixed end 104. The fixed end 104 of gripper finger 102 couples to the body 52 of robotic arm 50 with the free end 106 of gripper finger 102 spaced from the body 52. Additionally, while gripper finger 102 is shown as rectilinear in FIGS. 2-5, it may be understood that the shape of gripper finger 102 may vary in other embodiments. For example, in some embodiments gripper finger 102 may not be elongate in shape and instead may be square or claw-shaped and configured to grip objects from above, below, or other directions.

In this exemplary embodiment, gripper pad 120 extends longitudinally between a pair of longitudinal ends and defines a lateral interior side 122 and a lateral exterior side 124 opposite the interior side 122 of the gripper pad 120. The interior side 122 of gripper pad 120 defines a gripping surface 126 of the gripper pad 120 which contacts the object to be gripped by the gripper 100. Although the gripping surface 126 is shown as generally planar in FIGS. 2-5, it may be understood that the configuration of gripping surface 126 as well as other features of gripper pad 120 may vary in other embodiments. Additionally, it may be understood that both gripper pad 120 as well as gripper finger 102 described above may be formed from various materials including metallic, polymeric, elastomeric, and other materials such as, for example, composites, alloyed materials, and polymers, which can incorporate carbon fiber-including materials and/or glass-based materials, etc.

Gripper pad 120 is pivotably connected to the free end 106 of gripper finger 102 by a pivot joint 130 (shown schematically in outline in FIGS. 2-5) having a first end received within an internal receptacle formed in the free end 106 of gripper finger 102, and a second end longitudinally opposite the first end which projects from the gripper finger 102 and is received in a corresponding receptacle formed in a lateral proximal side 128 of the gripper pad 120 which faces and is positioned directly adjacent the gripper finger 102. In this exemplary embodiment, pivot joint 130 comprises a pivot pin and thus may also be referred to herein as pivot pin 130. However, it may be understood that in other embodiments pivot joint 130 may comprise other joints which allow for relative rotation between gripper finger 102 and gripper pad 120. As an example, in some embodiments, pivot joint 130 may comprise a bearing, a journal, a flexible member or spring, etc. The pivot joint 130 defines and extends along a rotational axis 135 about which the gripper pad 120 is permitted to pivot or rotate in each rotational direction (indicated by arrows 137 and 139 in FIGS. 4 and 5) relative to the gripper finger 102. Particularly, FIG. 4 illustrates a first rotational direction 137 about which gripper pad 120 may rotate relative to gripper finger 102 while FIG. 5 illustrates an opposed second rotational direction 139 about which gripper pad 120 may rotate relative to gripper finger 102. While in this exemplary embodiment gripper pad 120 is pivotably coupled to the gripper finger 102 through pivot joint 130, it may be understood that in other embodiments gripper pad 120 may be pivotably coupled to gripper finger 102 through other pivotable joints or couplings which vary in configuration from pivot joint 130. As an example, in some embodiments gripper pad 120 may pivotably couple to gripper finger 102 at a plurality of spaced pivot points (e.g., with one pivot point on each side 122, 124 of the gripper pad 120) to permit, in at least some applications, a greater degree of flexibility between the gripper pad 120 and gripper finger 102. It may also be understood that pivot joint 130 is merely one embodiment of a pivot point and that in other embodiments pivot joint 130 may be replaced or supplemented with other pivot joints such as fasteners, couplers including couplers formed from flexible materials permitting the coupler to flex a desired degree or amount, and other mechanisms.

The gripper pad aligner 150 of gripper 100 is also coupled between the gripper pad 120 and the gripper finger 102 to maintain the gripper pad 120 in a desired angular orientation about the rotational axis 135 relative to the gripper finger 102. Particularly, gripper pad aligner 150 maintains the gripper pad 120 in the desired angular orientation when the gripper pad 120 is not engaged by an object such that the object rotates the gripper pad 120 about the rotational axis 135 from the desired angular orientation. To state in other words, while gripper pad aligner 150 is configured to maintain the gripper pad 120 in the desired angular orientation relative to gripper finger 102, gripper pad aligner 150 still permits for relative rotation between the gripper pad 120 and gripper finger 102 about the rotational axis 135.

In this exemplary embodiment, the desired angular orientation of gripper pad 120 corresponds to an orientation in which a longitudinal axis 105 of gripper finger 102 (shown in FIG. 3) is oriented substantially parallel with a longitudinal axis 125 of gripper pad 120 (also shown in FIG. 3). As used herein, the term “substantially parallel” refers to an arrangement in which two members may be parallel to each other or within +5° of parallel with each other. It may be understood that in other embodiments the desired angular orientation of gripper pad 120 may not correspond to an orientation in which the longitudinal axis 105 of gripper finger 102 is oriented substantially parallel with the longitudinal axis 125 of gripper pad 120. For example, in some embodiments, the desired angular orientation of gripper pad 120 may correspond to an orientation in which the longitudinal axis 105 of gripper finger 102 is oriented at a substantially 10° (between 5° and 15°) angle from the longitudinal axis 125 of gripper pad 120. In some embodiments, the desired angular orientation of gripper pad 120 may correspond to an orientation in which the longitudinal axis 105 of gripper finger 102 is oriented at a substantially 20° (between 15° and 25°) angle from the longitudinal axis 125 of gripper pad 120. In certain embodiments, the desired angular orientation of gripper pad 120 may correspond to an orientation in which the longitudinal axis 105 of gripper finger 102 is oriented at a substantially 30° (between 25° and 35°) angle from the longitudinal axis 125 of gripper pad 120.

With gripper pad 120 in the desired angular orientation, a width 101 (shown in FIG. 3) of the gripper 100 is minimized. However, it may be understood that in other embodiments the desired angular orientation may vary. For instance, in some embodiments, the desired angular orientation may correspond to an orientation of the longitudinal axis 125 of gripper pad 120 at a desired non-zero angle to the longitudinal axis 105 of gripper finger 102.

As shown particularly in FIG. 2, gripper pad aligner 150 is offset from the rotational axis 135 by a desired offset distance 141 (extending radially outwards from rotational axis 135) and is coupled between the gripper finger 102 and gripper pad 120. Additionally, gripper pad aligner 150 generally includes a pad alignment element 152 and a finger alignment element 156 coupled to the pad alignment element 152. Not intending to be bound by any particular theory, it may generally be understood that a given force (F) may produce a corresponding torque (T) in relation to the magnitude of the position vector or moment arm (R) in accordance with Equation (1) presented below:

$$T = R \times F \qquad ( 1 )$$

In view of the above, for a given self-aligning force applied by the pad alignment element 152, the self-aligning torque applied by the element 152 against gripper pad 120 is correlated with the magnitude of the offset distance 141 (extending perpendicular to the self-aligning force and corresponding to the moment arm (R)), with the self-aligning torque increasing in magnitude concomitantly with an increase in the magnitude of offset distance 141. The pad alignment element 152 is coupled to the gripper pad 120 while the finger alignment element 156 is coupled to the gripper finger 102. Particularly, pad alignment element 152 may be coupled to an exterior surface of the gripper pad 120 such as to the interior side 122 or to the proximal side 128 of gripper pad 120. Alternatively, pad alignment element 152 may be received within an internal opening or receptacle formed within the gripper pad 120. Additionally, pad alignment element 152 may be releasably or permanently coupled to the gripper pad 120. Alternatively, pad alignment element 152 may be formed integrally or monolithically with the gripper pad 120.

Similarly, finger alignment element 156 may be coupled to an exterior surface of the gripper finger 102. Alternatively, finger alignment element 156 may be received within an internal opening or receptacle formed within the gripper finger 102. Additionally, finger alignment element 156 may be releasably or permanently coupled to the gripper finger 102. Alternatively, finger alignment element 156 may be formed integrally or monolithically with the gripper finger 102.

Pad alignment element 152, being coupled to gripper pad 120, is generally configured to apply a self-aligning torque (in either of the rotational directions 137 or 139 shown in FIGS. 4 and 5) to the gripper pad 120 about the rotational axis 135 whereby the gripper pad 120 is rotated by the pad alignment element 152 (when the gripper pad 120 is not obstructed by an exterior object) about the rotational axis 135 toward the desired angular orientation. Particularly, pad alignment element 152 may apply a self-aligning force to the gripper pad 120 that is converted into a torque about the rotational axis 135 where the offset distance 141 defines a moment arm of the torque applied by the pad alignment element 152 against the gripper pad 120. Finger alignment element 156 may, in some embodiments, react against the gripper finger 102 the force applied by the pad alignment element 152 against the gripper pad 120. In this manner, the force applied by the pad alignment element 152 against the gripper pad 120 may be reacted or transferred from the pad alignment element 152 to the finger alignment element 156, and from the finger alignment element 156 to the gripper finger 102. In this manner, forces may be transferred from finger alignment element 156 to the pad alignment element 152.

In some embodiments, finger alignment element 156 is mechanically coupled to the pad alignment element 152 such that a mechanical connection is provided between elements 152 and 156. For example, pad alignment element 152 may be releasably or permanently mechanically coupled to the finger alignment element 156 such as at a joint formed therebetween. Alternatively, finger alignment element 156 may be formed integrally or monolithically with the pad alignment element 152. For instance, in some embodiments, gripper pad aligner 150 may comprise a single monolithically formed element or member which defines both the pad alignment element 152 and finger alignment element 156.

In other embodiments, finger alignment element 156 is coupled to pad alignment element 152 in ways other than through a mechanical coupling or connection. For example, finger alignment element 156 is magnetically coupled to the pad alignment element 152 in some embodiments such that a magnetic force may be transmitted between elements 152 and 156 of gripper pad aligner 150 to thereby rotate the gripper pad 120 toward the desired angular orientation shown in FIG. 3. In this manner, force may be transferred magnetically between elements 152 and 156 of gripper pad aligner 150 so as to provide an aligning force by the pad alignment element 152 to the gripper pad 120 that is offset from the rotational axis 135 by a moment arm corresponding to the offset distance 141 between the rotational axis 135 and elements 152 and 156, resulting in the application of a torque to the gripper pad 120 in the rotational direction of the desired angular orientation. The aligning force ceases to be applied to the gripper pad 120 once gripper pad 120 reaches the desired angular orientation, thereby maintaining gripper pad 120 in the desired angular orientation until or unless a counteracting force (e.g., resulting from contact between gripper pad 120 and an external object) is applied to the gripper pad 120 sufficient to rotate the gripper pad 120 from the desired angular orientation. The gripping ability of gripper pad 120 may be maximized when in the desired angular orientation, permitting the gripper pad 120 to more securely grip a variety of differently shaped objects as compared to the ability of gripper pad 120 to securely grip objects when in an orientation that deviates from the desired angular orientation. As an example, in some applications when gripper pad 120 deviates from a substantially parallel arrangement relative to gripper finger 102 the gripper pad 120 may contact the object to be grasped at a location along the longitudinal length of the gripper pad 120 (e.g., a location proximal the longitudinal ends of gripper pad 120) that is not conducive for maximizing a gripping force applied to the object by the gripper pad 120.

It may be understood that in other embodiments the pad alignment element 152 may be coupled to the finger alignment element 156 other than mechanically or magnetically whereby forces may be transferred between elements 152 and 156. For example, pad alignment element 152 may be fluidically coupled to the finger alignment element 156.

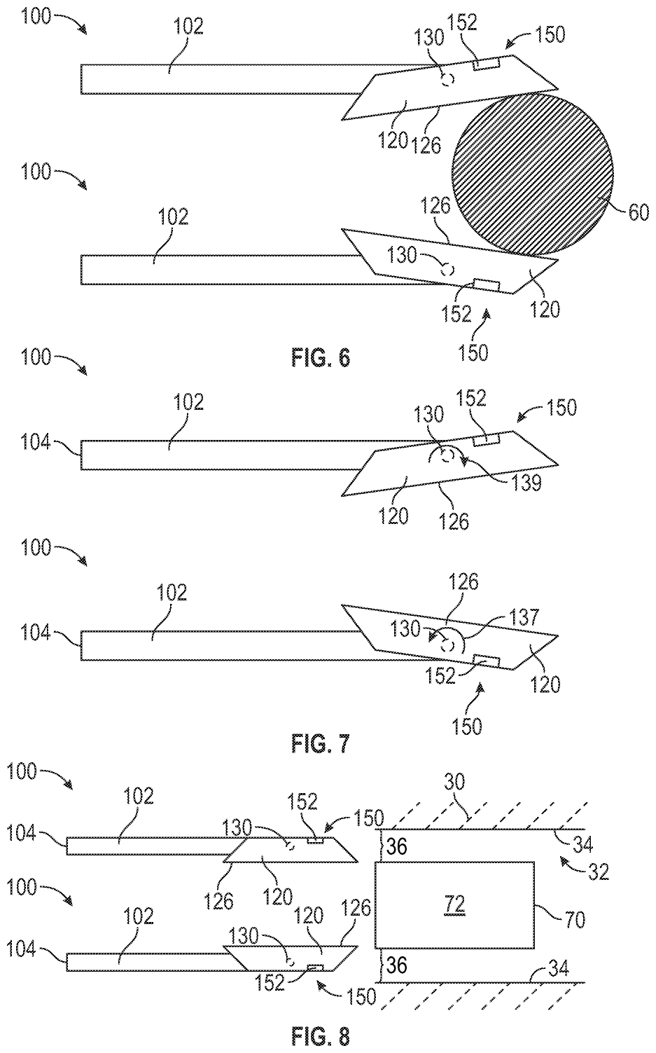

Referring now to FIGS. 6-8, features of the operation of gripper 100 will now be described. Particularly, FIG. 6 illustrates a pair of grippers 100 (which may be a part of robotic arm 50 not shown in FIG. 6) in the process of grasping a first object 60 having an exterior size and shape that results in the gripper pads 120 of grippers 100 deviating from their desired angular orientations (such that pads 120 are oriented parallel fingers 102) so that pads 120 may grasp the object 60. FIG. 6 thus illustrates that gripper pad aligners 150 permit gripper pads 120 to deviate from their desired angular orientations when required to permit the gripper pads 120 to grip an object, such as the object 60 shown in FIG. 6.

FIG. 7 illustrates the pair of grippers 100 immediately following the release of object 60 with gripper pads 120 deviating from their desired angular orientations. In this configuration, the pad alignment elements 152 of gripper pad aligners 150 apply an aligning torque to the gripper pads 120 of grippers 100, thereby rotating the gripper pads 120 about the rotational axes 135 of grippers 100 until the gripper pads 120 are restored in their desired angular orientations as shown in FIG. 8.

Particularly, FIG. 8 illustrates the pair of grippers 100 with gripper pads 120 restored to their desired angular orientations by the gripper pad aligners 150. In this configuration, the pair of grippers 100 are configured to grasp a second object, for example, in the form of an assay plate 70, which may contain one or more of biological samples, reagents 72, etc. and which is housed within one of the receptacles 32 (defined by a pair of opposing walls 34 in FIG. 8) of the assay storage unit 30. Moreover, it may be understood that in the desired angular orientations the gripping capability of the pair of grippers 100 is maximized when contacting and gripping the second object. In this configuration, a pair of openings 36 are formed between the lateral sides of assay plate 70 and the walls 34 defining the receptacle 32 in which assay plate 70 is positioned.

In order to minimize the size of each receptacle 32 and the overall footprint of assay storage unit 30, the size of each opening 36 may be slightly larger than the width 101 of gripper 100 (as illustrated, for example, in FIG. 3), when gripper pad 120 is in the desired angular orientation (as shown in FIG. 8 with the longitudinal axis 125 of pad 120 parallel with the longitudinal axis 105 of gripper finger 102. Thus, the width of gripper 100 may exceed the size of a given opening 36 (due to the gripper pad 120 extending at a non-zero angle relative to the gripper finger 102 as shown in FIG. 7—effectively widening the gripper 100) preventing the gripper 100 from entering the receptacle 32. For example, without gripper pad aligners 150, gripper pads 120 may remain offset from their desired angular orientations, potentially leading to an undesirable impact or crash between gripper pads 120 and the walls 34 of receptacle 32 and/or assay plate 70 as the grippers 100 travel toward receptacle 32. An impact between grippers 100 and the assay storage unit 30 and/or assay plate 70 may damage the robotic arm 50 and assay storage unit 30, and/or otherwise result in a stoppage of the operation of assay system 10. It may also be understood that with gripper pads 120 offset from their desired angular orientations the gripping capability of gripper pads 120 for grasping objects may not be maximized, thus decreasing the effectiveness of gripper pads 120 in grasping the objects. Conversely, with gripper pads 120 maintained in their respective desired angular orientations by gripper pad aligners 150, gripper pads 120 may be inserted into the openings 36 such that the gripping surfaces 126 of gripper pads 120 may grasp onto an exterior surface of the assay plate 70 without impacting or crashing into the walls 34 of receptacle 32. It may be additionally understood that assay plate 70 is but one example of an object of the assay system 10 that may be grasped by the grippers 100. Examples of other objects of assay system 10 which may be grasped by grippers 100 includes various boxes, containers, pipette tips, vials, test tubes and/or other objects utilized by assay system 10. Moreover, in addition to gripping and transporting various objects, grippers 100 may also be utilized to manipulate or operate various instruments or other components of assay system 10. For example, grippers 100 may be used to operate various input/output (I/O) devices of assay system 10 including switches, buttons, joysticks, keypads and other devices.

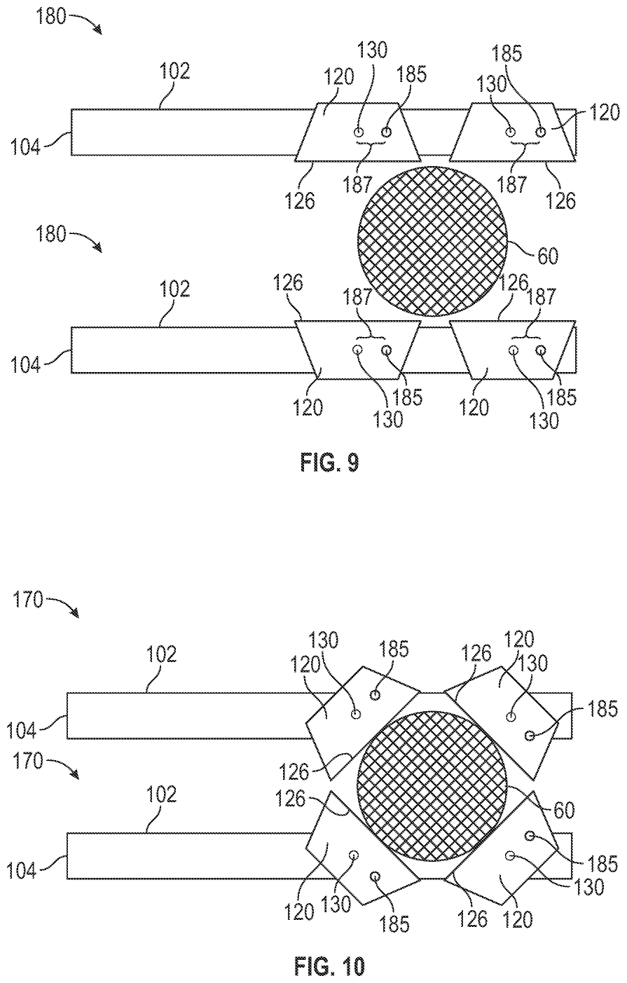

Referring now to FIGS. 9 and 10, another embodiment of a gripper 180 for a robotic arm (e.g., robotic arm 50 shown in FIG. 1) is shown. Particularly, FIGS. 9 and 10 illustrate a pair of grippers 180 for grasping the object 60. Grippers 180 may include features in common with the gripper 100 described above, and shared features are labeled similarly. In this exemplary embodiment, each gripper 180 generally includes a gripper finger 102, a pair of gripper pads 120, and a pair of gripper pad aligners 185 corresponding to the pair of gripper pads 120. Particularly, the pair of gripper pads 120 of each gripper 180 are spaced along the longitudinal length of gripper finger 102 and pivotably coupled to the gripper finger 102 via a pair of pivot joints 130 correspondingly longitudinally spaced along gripper finger 102. In this configuration, the pair of gripper pads 120 of each gripper 180 are permitted to rotate independently from each other relative to gripper finger 102.

Gripper pad aligners 185 of gripper 180 are coupled between the pair of gripper pads 120 and the gripper finger 102 with a first gripper pad aligner 185 being coupled and associated with a first gripper pad 120 of the gripper 180 while a second gripper pad aligner 185 is coupled and associated with a second gripper pad 120 of gripper 180. Gripper pad aligners 185 may be configured similarly as the gripper pad aligners 150 shown in FIGS. 2-8 and thus are not described in detail herein. Additionally, each gripper pad aligner 185 is offset from the rotational axis 135 of the pivot joint 130 associated with the given gripper pad aligner 185 by an offset distance 187 (shown in FIG. 9).

FIG. 9 illustrates grippers 180 prior to grasping the object 60 while FIG. 10 illustrates grippers 180 actively grasping the object 60. As shown in FIG. 9, prior to contacting the object 60, gripper pad aligners 185 maintain their associated gripper pads 120 in a desired angular orientation relative to gripper fingers 102. Particularly, in this exemplary embodiment, gripper pad aligners 185 maintain gripper pads 120 in a substantially parallel (as described above) relationship with the gripper fingers 102. As shown in FIG. 10, upon contacting the object 60, gripper pads 120 are permitted by gripper pad aligners 185 to rotate relative to their associated gripper fingers 102 whereby the gripping surfaces 126 of gripper pads 120 each extend tangentially relative to the outer surface of object 60, maximizing the gripping capability of grippers 180 in grasping the object 60.

While FIGS. 6-10 illustrate grippers 100 (FIGS. 7, 8) and 170 (FIGS. 9, 10) arranged in pairs, it may be understood that in other embodiments the grippers (grippers 100, 170, and/or others described herein) may not be paired. For example, in some embodiments, a robotic arm (e.g., robotic arm 50 shown in FIG. 1) may be provided with an odd number of grippers such as a single gripper, three grippers, etc.

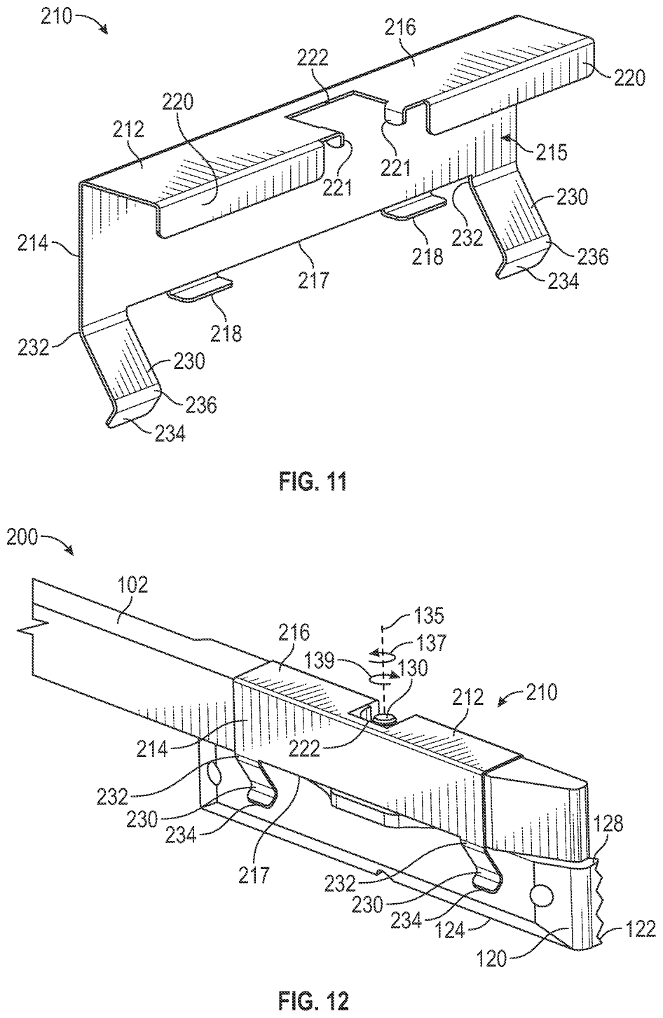

Referring now to FIGS. 11 and 12, another embodiment of a gripper pad aligner 210 (shown in FIG. 11) of a gripper 200 (shown in FIG. 12) for a robotic arm (e.g., robotic arm 50 shown in FIG. 1) is shown. Gripper pad aligner 210 generally includes a plurality of pad alignment elements 230 and a finger alignment element 212. In this exemplary embodiment, each pad alignment element 230 comprises biasing fingers and thus may also be referred to herein as biasing fingers 230. Additionally, in this exemplary embodiment, finger alignment element 212 comprises a base that is mechanically coupled to the plurality of biasing fingers 230, and thus may also be referred to herein as base 212. While in this exemplary embodiment the gripper pad aligner 210 includes a pair of biasing fingers 230 mechanically coupled to the base 212, it may be understood that in other embodiments the number and arrangement of biasing fingers 230 may vary. For example, in other embodiments, gripper pad aligner 210 may include a single biasing finger 230 or more than two biasing fingers 230.

In this exemplary embodiment, the base 212 of gripper pad aligner 210 includes a lateral side panel 214 and a lateral top panel 216 coupled to the side panel 214 at an angle such that base 212 defines a receptacle 215 into which the gripper finger 102 may be received. Additionally, base 212 includes a plurality of side tabs 218 extending at an angle from a lower edge 217 of the side panel 214, and a plurality of top tabs 220 and 221 each extending at an angle from an edge of the top panel 216. Particularly, a first pair of top tabs 220 are positioned along a side of the top panel 216 while a second pair of top tabs 221 are positioned along an opening 222 formed in the top panel 216. It may be understood that in other embodiments, the number and arrangement of tabs 218, 220 and/or 221 of the base 212 of gripper pad aligner 210 may vary. For example, in other embodiments, base 212 may only include one or more side tabs 218 but not top tabs 220 and/or 221. Conversely, in some embodiments, base 212 may only include one or more top tabs 220 and/or 221 but not any side tabs 218. In still other embodiments, base 212 may not include side tabs 218 or top tabs 220 and/or 221, and instead may be secured to gripper finger 102 through other means such as one or more fasteners.

In this exemplary embodiment, gripper 200 generally includes gripper finger 102, gripper pad 120, and the gripper pad aligner 210 coupled between the gripper finger 102 and gripper pad 120. The plurality of pad alignment elements 230 of gripper pad aligner 210 couple to the gripper pad 120 while the finger alignment element 212 of gripper pad aligner 210 couple to the gripper finger 102. Additionally, the tabs 218, 220, and 221 of base 212 are configured to be coupled with the gripper finger 102, for example, by snapping onto and conforming against the exterior of the gripper finger 102 to thereby secure the base 212 thereto such that relative movement between the gripper finger 102 and the base 212 is restricted when the base 212 is secured onto the finger 102. In this configuration, base 212 may be manually snapped onto the gripper finger 102 at a location proximal the end of gripper finger 102 whereby pivot joint 130 aligns with the opening 222 formed in the top panel 216. It may be understood that in other embodiments base 212 may couple with gripper finger 102 through means other than tabs 218, 220 and 221. For example, base 212 may couple with gripper finger 102 in some embodiments via one or more fasteners. As another example, in some embodiments, base 212 may comprise a magnet that magnetically couples to a corresponding magnet of the gripper finger 102. In this manner, tabs 218, 220 and 221 permit the base 212 of gripper pad aligner 210 to be coupled and secured to the gripper finger 102 of gripper 100 without needing to rely on separate fasteners, potentially minimizing the time required for attaching the gripper pad aligner 210 to the gripper finger 102. Gripper pad aligner 210 may be snapped onto gripper finger 102 during the initial assembly of gripper 100 or at a later time. It may however be understood that in other embodiments base 212 may be secured to the gripper finger 102 through a variety of mechanisms both releasable (e.g., one or more separate fasteners) and permanent (e.g., welding, adhesives). In still other embodiments, at least the base 212 of gripper pad aligner 210 may be formed integrally or monolithically with the gripper finger 102.

In this exemplary embodiment, each biasing finger 230 extends longitudinally between a first or fixed end 232 mechanically coupled to the base 212, and a second or free end 234 opposite the fixed end 232 and permitted to move or flex relative to the base 212. Particularly, the fixed end 232 of each biasing finger 230 couples to the base 212 along the lower edge 217 of side panel 214 whereby the biasing fingers 230 project from the lower edge 217 of base 212. Biasing fingers 230 may be formed from a relatively flexible and elastic material such as plastic material, a metallic material, etc., that allows the free end 234 of the biasing finger 230 to flex relative to the base 212 It may be understood that the flexible materials comprising biasing members 230 may be selected such that a maximum deflection condition of the biasing fingers 230 is within an elastic limit of the flexible materials. Additional materials can include, for example, stainless steel, Beryllium Copper, etc. Additionally, in this exemplary embodiment, each biasing finger 230 is bent along the longitudinal length thereof such that each finger 230 defines a contact surface 236 for contacting the exterior side 124 of the gripper pad 120. Specifically, contact surface 236 is oriented in the direction of the gripper pad 120 and is spaced from the fixed end 232 thereof. However, it may be understood that the shape of biasing fingers 230 may vary in other embodiments.

Additionally, it may be noted that the pair of biasing fingers 230 flank the pivot joint 130 such that a first biasing finger 230 is positioned along the longitudinal axis 105 of gripper finger 102 between the fixed end 104 of finger 102 and the pivot joint 130, while a second biasing finger 230 is positioned along axis 105 between the pivot joint 130 and the free end 106 of gripper finger 102. In this configuration, the first biasing finger 230 of gripper pad aligner 210 is engaged and flexed outwardly by the gripper pad 120 in response to gripper pad 120 rotating in the first rotational direction 137 relative to gripper finger 230. Flexed outwardly by the contact from gripper pad 120, the first biasing finger 230 applies a biasing force against the gripper pad 120 about a moment arm corresponding to the offset distance between the first biasing finger 230 and rotational axis 135, resulting in the application of a torque about the rotational axis 135 in the second rotational direction 139. Conversely, the second biasing finger 230 of gripper pad aligner 210 is engaged and flexed outwardly by the gripper pad 120 in response to gripper pad 120 rotating in the second rotational direction 139 relative to gripper finger 230. Flexed outwardly by the contact from gripper pad 120, the second biasing finger 230 applies a biasing force against the gripper pad 120 about a moment arm corresponding to the offset distance between the second biasing finger 230 and the rotational axis 135, resulting in the application of a torque about the rotational axis 135 in the first rotational direction 137. In summary, given that rotational axis 135 is located between the pair of biasing fingers 230 located along the same lateral side (exterior side 124) of gripper pad 120, biasing fingers 230 may rotate gripper pad 120 in either rotational direction 137 and 139 in order to maintain the gripper pad 120 in the desired angular orientation relative to gripper finger 102.

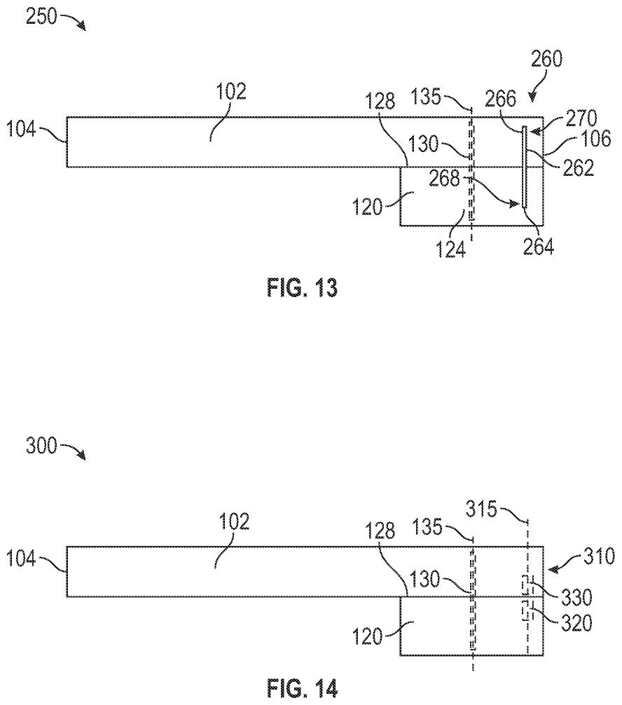

Referring to FIG. 13, a side view of another embodiment of a gripper 250 for a robotic arm (e.g., robotic arm 50 shown in FIG. 1) is shown. In this exemplary embodiment, gripper 250 generally includes gripper finger 102, gripper pad 120, and a gripper pad aligner 260 coupled between the gripper finger 102 and gripper pad 120. Gripper pad aligner 260 generally includes a spring wire 262 extending between a first or pad end 264 and a second or finger end 266 longitudinally opposite pad end 264. While in this exemplary embodiment spring wire 262 has a pair of longitudinally opposed ends 264 and 266, in other embodiments, spring wire 262 may be continuous and wrapped or positioned about the gripper finger 102 and gripper pad 120. Spring wire 262 is formed from a flexible, elastic material such as an elastomeric material and the like. In this configuration, a first section of the spring wire 262 including the pad end 264 defines a pad alignment element 268 of the gripper pad aligner 260 that is coupled to the gripper pad 120. Additionally, a second section of the spring wire 262 including the finger end 266 defines a finger alignment element 270 of the gripper pad aligner 260 that is coupled collectively to gripper finger 102 (including the fixed end 104 and free end 106 thereof), gripper pad 120 (including the exterior side 124, proximal side 128 thereof), and pivot joint 130.

In this exemplary embodiment, the pad alignment element 268 of gripper pad aligner 260 is mechanically coupled and formed integrally or monolithically with the finger alignment element 270. Gripper pad aligner 260 thus illustrates that embodiments of gripper pad aligners may comprise a single monolithically or integrally formed member in the form of spring wire 262 in this exemplary embodiment. Spring wire 262 is offset from the rotational axis 135 such that rotation of the gripper pad 120 relative to gripper finger 102 deforms (e.g., stretches) spring wire 262, resulting in spring wire 262 applying a force to the gripper pad 120. The force applied by spring wire 262 in response to deformation thereto is converted into a rotational torque about rotational axis 135 by the offset distance between spring wire 262 and axis 135, where the rotational torque rotates the gripper pad 120 back toward a desired angular orientation relative to the gripper finger 102.

Referring to FIG. 14, a side view of another embodiment of a gripper 300 for a robotic arm (e.g., robotic arm 50 shown in FIG. 1) is shown. In this exemplary embodiment, gripper 300 generally includes gripper finger 102, gripper pad 120, and a gripper pad aligner 310 coupled between the gripper finger 102 and gripper pad 120. In this exemplary embodiment, gripper pad aligner 310 includes a pad alignment element 320 coupled to the gripper pad 120 such that relative movement is restricted between pad 120 and element 320, and a finger alignment element 330 coupled to the gripper finger 102 such that, while relative movement between alignment elements 320 and 330 is permitted, relative movement between gripper finger 102 and finger alignment element 330 is restricted.

In this exemplary embodiment, alignment elements 320 and 330 each comprise magnetic materials such that elements 320 and 330 are magnetically coupled together rather than mechanically coupled together. In other words, pad alignment element 320 is not mechanically coupled to finger alignment element 330 except through the pivot joint 130 extending between gripper finger 102 and gripper pad 120. In other words, there is no direct mechanical coupling or connection between alignment elements 320 and 330.

Instead, magnetic materials of the alignment elements 320 and 330 each produce a magnetic field which interact and thereby produce a magnetic force on the alignment elements 320 and 330. In some embodiments, the magnetic materials comprising alignment elements 320 and 330 includes ferromagnetic materials, rare earth permanent magnetic materials, alloyed materials (e.g., aluminum-nickel-copper alloys, stainless steel alloys, etc.), metallic materials (e.g., iron, nickel, etc.), electromagnetic materials, and others. Additionally, it may be understood that alignment elements 320 and/or 330 may comprise separate elements which are coupled to the gripper pad 120 and gripper finger 102, respectively. Alternatively, alignment elements 320 and/or 330 may be formed integrally or monolithically (e.g., the finger 102 and/or pad 120 may at least partially be formed from magnetic materials) with the gripper pad 120 and gripper finger 102, respectively. Additionally, alignment elements 320 and 330 may be positioned along an exterior, such as, for example, through a mechanical, magnetic, etc. coupling) or within an interior opening or cavity of the gripper pad 120 and gripper finger 102, respectively. For example, in some embodiments, alignment elements 320 and 330 may not monolithically formed with gripper pad 120 and instead may be encapsulated within an internal cavity of the gripper pad 120.

In this exemplary embodiment, the magnetic materials of alignment elements 320 and 330 are configured such that pad alignment element 320 is magnetically attracted to the finger alignment element 330. While in this exemplary embodiment the elements 320 and 330 are magnetically attracted to each other, it may be understood that in other embodiments the alignment elements 320 and 330 may magnetically repel each other. Given that gripper pad aligner 310 is offset from the rotational axis 135 by an offset distance, the magnetic force produced by alignment elements 320 and 330 is applied about a moment arm corresponding to the offset distance, resulting in an aligning torque (in either rotational direction 137 and 139 depending on the starting position of gripper pad 120) applied by the pad alignment element 320 against the gripper pad 120 in the direction of the desired angular orientation of gripper pad 120. In this specific example, the magnetic force alignment elements 320 and 330 produce attract the pad alignment element 320 toward the finger alignment element 330 to minimize the physical distance between elements 320 and 330 such that, for example, elements 320 and 330 align along a common or shared longitudinal axis 315 as shown in FIG. 14 (illustrating the pad alignment element 320 as being positioned substantially below the finger alignment element 330 along axis 315). In this context, the term “substantially below” refers to an alignment in which the elements 320 and 330 fully align along the shared longitudinal axis 315 as well as alignments in which the elements 320 and 330 are offset from each other along that axis by +5° or less.

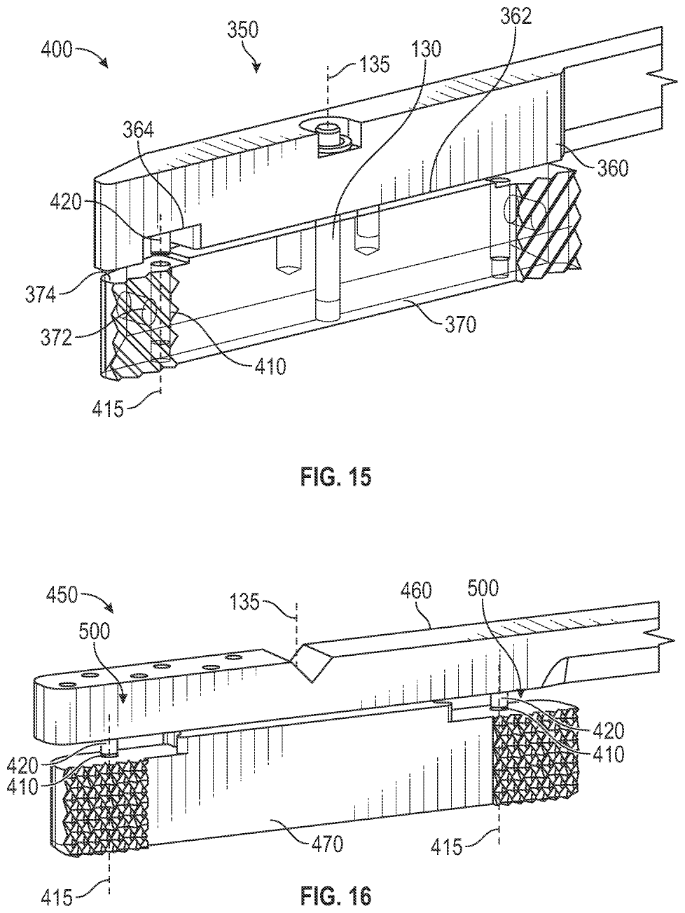

Referring to FIG. 15, a perspective view of another embodiment of a gripper 350 for a robotic arm (e.g., robotic arm 50 shown in FIG. 1) is shown. In this exemplary embodiment, gripper 350 generally includes gripper finger 360, gripper pad 370, and a gripper pad aligner 400 coupled between the gripper finger 360 and gripper pad 370. Gripper pad aligner 400 includes a pad alignment element 410 coupled to the gripper pad 370 such that relative movement is restricted between pad 370 and element 410, and a finger alignment element 420 coupled to the gripper finger 360 such that relative movement between gripper finger 360 and finger alignment element 420 is restricted.

Gripper finger 360 is similar in configuration to the gripper finger 102 shown in FIGS. 2-10 except that, in this exemplary embodiment, the finger alignment element 420 is formed integrally with the gripper finger 360 and is positioned along a lateral proximal side 362 (facing and adjacent to the gripper pad 370) of the gripper finger 360. Particularly, the finger alignment element 420 comprises a cylindrical boss in this exemplary embodiment and thus may also be referred to herein as boss 420. Boss 420 is surrounded by an annular channel 364 formed in the proximal side 362 of gripper finger 360 whereby boss 420 forms a projection on the proximal side 362 of gripper finger 360. Boss 420 is cylindrical in this exemplary embodiment but may comprise various other shapes (e.g., conical, prism-shaped having varying number of discrete sides). The shape of channel 364 may also vary depending on the shape of boss 420. As just one example, in an embodiment, boss 420 may be cuboid in shape having four discrete sides with channel 364 also having four corresponding sides flanking the sides of the boss 420. Additionally, gripper finger 360 is formed from magnetic materials in this exemplary embodiment, including boss 420. Thus, boss 420 comprises a magnetic element or member which produces a magnetic field extending therefrom. It may be understood that in other embodiments gripper pad 370 may comprise boss 420 while gripper finger 360 includes pad alignment element 410. Further, while boss 420 is formed integrally with gripper finger 360 in this exemplary embodiment, it may be understood that in other embodiments boss 420 may be formed separately from gripper finger 360 and coupled therewith. Similarly, pad alignment element 410 may either be formed integrally or monolithically with gripper pad 370, or formed separately from gripper pad 370 and coupled therewith.

The gripper pad 370 of gripper 300 is similar in configuration to the gripper pad 120 described above except that, in this exemplary embodiment, griper pad 370 defines an internal receptacle 372 that is radially spaced or offset from the rotational axis 135 (e.g., defined at pivot joint 130) and which receives the pad alignment element 410 of gripper pad aligner 400. Particularly, the receptacle 372 extends into a lateral proximal side 374 of the gripper pad 370 and is positioned such that the receptacle 372 extends concentrically with the boss 420 when the gripper pad 370 is in a desired angular orientation about the rotational axis 135 relative to the gripper finger 360 whereby a longitudinal axis of the gripper pad 370 extends substantially parallel to a longitudinal axis of the gripper finger 360. In this context, it may be understood that the term “substantially parallel” refers to an alignment in which the longitudinal axis of gripper finger 360 fully aligns with the longitudinal axis of gripper pad 370 as well as alignments in which the longitudinal axis of gripper finger 360 is offset from the longitudinal axis of gripper pad 370 by an angle that is +5° or less.

In this exemplary embodiment, pad alignment element 410 of gripper pad aligner 400 comprises a magnet or magnetic member, and thus may also be referred to herein as magnet 410. Magnet 410 is magnetically attracted to the boss 420 in this exemplary embodiment and, given that channel 364 forms a void space surrounding the boss 420, magnet 410 is urged to align with boss 420 such that a shared or common longitudinal axis 415 extends centrally through both magnet 410 and boss 420. In this configuration, the magnetic force produced by magnet 410 and boss 420 is applied to the gripper pad 370 as an aligning torque (due to the offset distance between magnet 410/boss 420 and the rotational axis 135) to rotate the gripper pad 370 in either rotational direction (depending on the original orientation of the gripper pad 370) so as to align the magnet 410 with the boss 420 along the shared longitudinal axis 415. While in this exemplary embodiment alignment of magnet 410 with boss 420 along the shared longitudinal axis 415 corresponds to the desired angular orientation of gripper pad 370, it may be understood that in other embodiments magnet 410, while being attracted to a magnetic member of gripper finger 360, may not align with boss 420 along a shared axis when pad 370 is in the desired angular orientation. It may be understood that while the void space formed by channel 364 is shown as annular in FIG. 15, in other embodiments both boss 420 and the surrounding void space may comprise various shapes and geometries including, for example, various prism-, cone-, cuboid-base shapes, etc.

Referring to FIG. 16, a perspective view of another embodiment of a gripper 450 for a robotic arm (e.g., robotic arm 50 shown in FIG. 1) is shown. In this exemplary embodiment, gripper 450 generally includes gripper finger 460, a gripper pad 470, and a pair of gripper pad aligners 500 each coupled between the gripper finger 460 and gripper pad 470.

Gripper 450 includes some features in common with the gripper 350 shown in FIG. 15. For example, each gripper pad aligner 500 includes a pad alignment element in the form of the magnet 410 coupled to the gripper pad 470 such that relative movement is restricted between pad 470 and magnet 410, and a corresponding finger alignment element in the form of the boss 420 coupled to the gripper finger 460 such that relative movement between gripper finger 460 and finger alignment element 420 is restricted. Although gripper pad aligners 500 are shown in FIG. 16 as including pad alignment elements in the form of magnets 410 and finger alignment elements in the form of bosses 420, in other embodiments, the pad alignment elements of gripper pad aligners 500 may comprise elements other than magnets and/or the finger alignment elements of gripper pad aligners 500 may comprise elements other than bosses.

As with the gripper pad aligner 400 shown in FIG. 15, the magnet 410 of each gripper pad aligner 500 is magnetically attracted to the corresponding boss 420 of the respective gripper pad aligner 500 whereby magnet 410 is urged to align with boss 420 such that a shared or common longitudinal axis 415 of the respective gripper pad aligner 500 extends centrally through both magnet 410 and boss 420. In this configuration, the magnetic force produced by each gripper pad aligner 500 is applied to the gripper pad 470 as an aligning torque (due to the offset distance between the respective gripper pad aligner 500 and the rotational axis 135) to rotate the gripper pad 470 in either rotational direction (depending on the original orientation of the gripper pad 470) so as to align the magnet 410 with the boss 420 along the shared longitudinal axis 415 for each gripper pad aligner 500.

Additionally, gripper pad aligners 500 are located on opposing sides of the rotational axis 135 such that axis 135 is located between the gripper pad aligners 500 along a common longitudinal axis (e.g., the longitudinal axis of gripper finger 460). In this configuration, each gripper pad aligner 500 applies an aligning torque to the gripper pad 470 in the same rotational direction about rotational axis 135. In other words, the aligning torque applied by a first of the gripper pad aligners 500 is augmented by the aligning torque applied by a second of the gripper pad aligners 500. The additional aligning torque applied by the second gripper pad aligner 500 of the pair of gripper pad aligners 500 increases the stability and self-centering capabilities of the gripper pad 470, making the gripper pad 470 generally more resistant to rotating about rotational axis 135.

In this exemplary embodiment, gripper pad aligners 500 apply roughly equal amounts of aligning torque to the gripper pad aligner 470; however, in other embodiments, the amount of aligning torque produced by gripper pad aligners 500 may vary depending on the length of the moment arm (R) and/or the magnitude the aligning force (F) applied by gripper pad aligner 500. For example, a first gripper pad aligner 500 may produce a greater magnetic force than the second gripper pad aligner 500 such that the aligning torque produced by the first gripper pad aligner 500 is greater than the aligning torque produced by the second gripper pad aligner 500. Moreover, while a pair of gripper pad aligners 500 are shown in FIG. 16, in other embodiments, gripper 450 may include more than two gripper pad aligners 500 (e.g., three, four, five, or six gripper pad aligners 500).

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A gripper assembly for a robotic arm, the gripper assembly comprising:
a gripper finger having a longitudinal first end and a longitudinal second end opposite the first end;
a gripper pad pivotably coupled to the gripper finger such that the gripper pad is permitted to rotate about a rotational axis relative to the gripper finger, the gripper pad having a pair of lateral sides with one of the lateral sides forming a gripping surface configured to grip an object, and a proximal side located between the pair of lateral sides; and
a gripper pad aligner comprising a pad alignment element coupled to the gripper pad and a finger alignment element coupled to the gripper finger, wherein the pad alignment element is coupled to the finger alignment element and configured to apply an aligning torque to the gripper pad that, when applied, rotates the gripper pad toward a first angular orientation about the rotational axis between the gripper pad and the gripper finger.

2. The gripper assembly of claim 1, wherein the pad alignment element comprises a biasing member configured to apply a biasing force to the gripper pad that, when applied, rotates the gripper pad toward the first angular orientation.

3. The gripper assembly of claim 1, wherein the pad alignment element comprises at least one of:
a spring wire wherein the biasing force applied by the spring wire results from an elongation of the spring wire; and
a biasing finger having a fixed end coupled to the finger alignment element and a free end opposite the fixed end, and wherein the biasing force applied by the biasing finger results from a bending of the biasing finger.

4. The gripper assembly of claim 1, wherein the finger alignment element comprises a base securable to the gripper finger and the pad alignment element comprises a biasing finger extending from the base toward the gripper pad, and wherein at least a portion of the biasing finger abuts one of the lateral sides of the gripper pad to bias the gripper pad toward the first angular orientation.

5. The gripper assembly of claim 4, wherein:
the base comprises a top panel positioned along a proximal side of the gripper finger, and one or more first tabs extending from the top panel at a non-zero angle for securing the base to the gripper finger; and
the base comprises a side panel extending from the top panel and positioned along a lateral side of the gripper finger, and one or more second tabs extending from the side panel at a non-zero angle for securing the base to the gripper finger.

6. The gripper assembly of claim 4, wherein the pad alignment element comprises a plurality of the biasing fingers each abutting a first lateral side of the pair of lateral sides of the gripper pad to bias the gripper pad toward the first angular orientation.

7. The gripper assembly of claim 1, wherein the pad alignment element comprises a first magnetic member and the finger alignment element comprises a second magnetic member magnetically coupled to and magnetically attracted toward the first magnetic member.

8. The gripper assembly of claim 7, wherein the second magnet member is formed integrally with the gripper finger.

9. The gripper assembly of claim 7, wherein the second magnetic member comprises a boss surrounded by a channel formed in a surface of the gripper finger, and wherein the boss extends toward the proximal side of the gripper pad and is aligned with the first magnetic member when the gripper finger is in the first angular orientation.

10. The gripper assembly of claim 9, wherein the first magnetic member comprises a magnet attachable to the gripper pad.

11. The gripper assembly of claim 1, further comprising:
a plurality of the gripper pads each pivotably coupled to the gripper finger such that the plurality of the gripper pads are permitted to rotate about a plurality of the rotational axes relative to the gripper finger;
wherein the plurality of rotational axes are spaced longitudinally along the gripper finger.

12. The gripper assembly of claim 1, further comprising a plurality of the gripper pad aligners.

13. The gripper assembly of claim 1, wherein:
the gripper pad aligner comprises a first gripper pad aligner, the pad alignment element comprises a second pad alignment element, and the finger alignment element comprises a second finger alignment element;
the gripper assembly comprises a second gripper pad aligner comprising a first gripper pad aligner, the pad alignment element comprises a second pad alignment element, and the finger alignment element comprises a second finger alignment element; and
the rotational axis is arranged longitudinally along the gripper finger between the first gripper pad aligner and the second gripper pad aligner.

14. The gripper assembly of claim 13, wherein:
the first pad alignment element comprises a first magnetic member and the first finger alignment element comprises a second magnetic member magnetically coupled to and magnetically attracted toward the first magnetic member; and
the second pad alignment element comprises a third magnetic member and the second finger alignment element comprises a fourth magnetic member magnetically coupled to and magnetically attracted toward the third magnetic member.

15. An assay system, comprising:
a container containing a reagent; and
a pair of robotic arms configured to manipulate the position of the container, wherein each of the robotic arms comprises a pair of the gripper assemblies of claim 1 configured to grip the container between the pair of robotic arms.

16. A gripper assembly for a robotic arm, the gripper assembly comprising:
a gripper finger having a longitudinal first end and a longitudinal second end opposite the first end;
a gripper pad pivotably coupled to the gripper finger such that the gripper pad is permitted to rotate about a rotational axis relative to the gripper finger, the gripper pad having a pair of lateral sides with one of the lateral sides forming a gripping surface configured to grip an object, and a proximal side located between the pair of lateral sides; and
a gripper pad aligner comprising a pad alignment element coupled to the gripper finger and offset from the rotational axis by a predetermined distance, wherein the pad alignment element is configured to apply an aligning torque to the gripper pad oriented in the direction of a first angular orientation about the rotational axis between the gripper pad and the gripper finger.

17. The gripper assembly of claim 16, wherein the pad alignment element comprises a magnetic member received in an aperture formed in the proximal side of the gripper pad.

18. The gripper assembly of claim 16, wherein the gripper pad aligner comprises a magnetic boss extending from a side of the gripper finger and surrounded by a channel formed in the side of the gripper finger, and wherein the magnetic boss magnetically attracts the pad alignment element and is aligned with the pad alignment element when the gripper finger is in the first angular orientation.

19. The gripper assembly of claim 16, wherein the pad alignment element comprises a magnet coupled to the gripper pad.

20. The gripper assembly of claim 16, wherein the pad alignment element comprises at least one of:
an elongate biasing finger which abuts one of the pair of lateral sides of the gripper pad and extends toward the gripper finger;
a spring wire and the aligning torque comprises a biasing force applied by the spring wire due to an elongation of the spring wire; and
a first magnetic member and the finger alignment element comprises a second magnetic member magnetically attracted toward the pad alignment element.

21. The gripper assembly of claim 16, wherein the gripper pad aligner comprises a finger alignment element coupled to the gripper pad and offset from the rotational axis by the predetermined distance.

22. The gripper assembly of claim 16, wherein:
the gripper pad comprises a second angular orientation that is spaced from the first angular orientation in a first rotational direction about the rotational axis, and wherein the alignment element applies a rotational torque in a second rotational direction, opposite the first rotational direction, when the gripper pad is in the second angular orientation; and
the gripper pad comprises a third angular orientation that is spaced from the first angular orientation in the second rotational direction about the rotational axis, and wherein the alignment element applies a rotational torque in the first rotational direction when the gripper pad is in the third angular orientation.

23. The gripper assembly of claim 16, wherein the alignment element is configured to restore the gripper pad to the first angular orientation when the gripper pad is in a second angular orientation spaced from the first angular orientation in a first rotational direction, and when the gripper pad is in a third angular orientation spaced from the first angular orientation in a second rotational direction, opposite the first rotational direction.

24. The gripper assembly of claim 16, further comprising a plurality of the gripper pads each pivotably coupled to the gripper finger such that the plurality of the gripper pads are permitted to rotate about a plurality of the rotational axes relative to the gripper finger.

25. The gripper assembly of claim 16, wherein:
the gripper pad aligner comprises a first gripper pad aligner, the pad alignment element comprises a second pad alignment element, and the finger alignment element comprises a second finger alignment element;
the gripper assembly comprises a second gripper pad aligner comprising a first gripper pad aligner, the pad alignment element comprises a second pad alignment element, and the finger alignment element comprises a second finger alignment element; and
the rotational axis is arranged longitudinally along the gripper finger between the first gripper pad aligner and the second gripper pad aligner.

26. A gripper assembly for a robotic arm, the gripper assembly comprising:
a gripper finger having a longitudinal first end and a longitudinal second end opposite the first end;
a gripper pad pivotably coupled to the gripper finger such that the gripper pad is permitted to rotate about a rotational axis relative to the gripper finger, the gripper pad having a pair of lateral sides with one of the lateral sides forming a gripping surface configured to grip an object, and a proximal side located between the pair of lateral sides; and
a gripper pad aligner comprising a base securable to the gripper finger and a biasing finger extending from the base toward the gripper pad and abutting one of the lateral sides of the gripper pad.

27. The gripper assembly of claim 26, wherein the biasing finger comprises a pair of the biasing fingers each abutting a first lateral side of the pair of lateral sides of the gripper pad, and wherein the pair of the biasing fingers are at locations spaced from each other along a longitudinal axis of the gripper pad.

28. The gripper assembly of claim 26, wherein:
the gripper pad aligner comprises a first gripper pad aligner, the pad alignment element comprises a second pad alignment element, and the finger alignment element comprises a second finger alignment element; and
the gripper assembly comprises a second gripper pad aligner comprising a first gripper pad aligner, the pad alignment element comprises a second pad alignment element, and the finger alignment element comprises a second finger alignment element; and
the rotational axis is arranged longitudinally along the gripper finger between the first gripper pad aligner and the second gripper pad aligner.

29. A gripper assembly for a robotic arm, the gripper assembly comprising:
a gripper finger having a longitudinal first end and a longitudinal second end opposite the first end;
a gripper pad having a pair of lateral sides with one of the lateral sides forming a gripping surface configured to grip an object, and a proximal side located between the pair of lateral sides; and
a gripper pad aligner comprising a first magnetic member coupled to the gripper finger and a second magnetic member coupled to the gripper pad and magnetically attracted to the first magnetic member, wherein the second magnetic member is configured to apply an aligning torque to the gripper pad oriented in the direction of a first angular orientation about a rotational axis between the gripper pad and the gripper finger.

30. A gripper pad aligner for a gripper assembly of a robotic arm, the gripper pad aligner comprising:
a pad alignment element configured to couple to a gripper pad of the gripper assembly; and
a finger alignment element configured to couple to a gripper finger of the gripper assembly, wherein the pad alignment element is configured to couple to the finger alignment element and configured to apply an aligning torque to the gripper pad when the finger alignment element is coupled to the gripper pad that, when applied, rotates the gripper pad toward a first angular orientation about a rotational axis between the gripper pad and the gripper finger.
